(19) United States
(12) Patent Application Publication
(10) Pub. No.: US 2025/0272804 A1
(43) Pub. Date: Aug. 28, 2025

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventors: TAISUKE NISHIO, Kanagawa (JP); MASASHI YAMAMOTO, Kanagawa (JP); TATSUYA TSUJI, Kanagawa (JP); NATSUKO SATO, Kanagawa (JP)

(21) Appl. No.: 19/056,902

(22) Filed: Feb. 19, 2025

(30) Foreign Application Priority Data
Feb. 27, 2024 (JP) 2024-027871

(51) Int. Cl. G06T 5/73; G06T 5/20; G06T 5/40; G06T 5/92; G06T 9/00

(52) U.S. Cl. CPC G06T 5/73; G06T 5/20; G06T 5/40; G06T 5/92; G06T 9/00; G06T 2207/20192; G06T 2207/20201

(57) ABSTRACT

An image processing apparatus includes one or more memories storing instructions and one or more processors that execute the instructions to reduce turbulence in an image based on turbulence information, and to correct, based on the turbulence information and a spatial change in luminance in the image, contrast of the image.

### CROSS-REFERENCE TO PRIORITY APPLICATION

This application claims the benefit of Japanese Patent Application No. 2024-027871, filed Feb. 27, 2024, which is hereby incorporated by reference herein in its entirety.

### BACKGROUND OF THE INVENTION

### Field of the Invention

The present invention relates to a technique for reducing turbulence in an input image.

### Description of the Related Art

In surveillance camera use cases such as port surveillance and infrastructure surveillance, when, for example, telephotography of a ship or an aircraft is performed, turbulence in a subject image caused by uneven changes in the refractive index of atmosphere (e.g., a heat haze) is known to cause a decrease in the visibility of a subject. In response to that, International Publication No. 2015/132826, for example, discloses a technique in which a turbulence intensity is determined using an input image, and turbulence is corrected by frame images being averaged in a time direction (frame direction) according to the determined turbulence intensity. According to the technique disclosed in International Publication No. 2015/132826, even when the turbulence intensity changes according to an imaging environment, the turbulence can be appropriately corrected. In addition, International Publication No. 2015/132826 discloses, since the image ends up being blurred due to image averaging being performed, a technique for reducing blurring caused by image averaging by performing image sharpening according to the turbulence intensity on the image that has been subjected to turbulence reduction. Further, International Publication No. 2015/132826 discloses that the greater the turbulence intensity, the greater the filter size of an image sharpening filter.

However, in the technique disclosed in International Publication No. 2015/132826, there is a possibility that turbulence may end up being emphasized due to image sharpening being performed, and that the effect of turbulence reduction may thereby be weakened. For example, in the technique disclosed in International Publication No. 2015/132826, the greater the turbulence intensity, the greater the degree of sharpening of an image, but the greater the turbulence intensity, the greater the possibility that there may be a turbulence correction remainder. Further, a case where when a subject is a moving object, since a subject image becomes blurred due to frame image averaging, the number of frame images to be averaged cannot be increased, and because turbulence reduction cannot be strongly applied, a turbulence correction remainder occurs is conceivable. If a degree of sharpening is increased when such a turbulence correction remainder occurs, since the turbulence correction remainder becomes emphasized due to sharpening, there is a possibility that the effect of turbulence reduction may be weakened. In addition, such emphasis of a turbulence correction remainder becomes more noticeable in a region where a spatial change in an image of a subject is small, such as a region where luminance values of the image are close to flat. In a region where a spatial change in an image of a subject is large, even if a turbulence correction remainder is emphasized, since the image of the subject will also be emphasized at the same time, the turbulence correction remainder will be less noticeable. Meanwhile, if turbulence slightly occurring in a flat portion of an image is emphasized, since a spatial change in an image of a subject is small, the subject will not be too much emphasized, and emphasis of the turbulence correction remainder becomes relatively noticeable, and, as a result, the effect of turbulence reduction may be weakened.

### SUMMARY OF THE INVENTION

The present invention provides a technique for reducing blurring caused by turbulence reduction while preventing a turbulence correction remainder from being emphasized.

According to the first aspect of the present disclosure, there is provided an image processing apparatus comprising one or more memories storing instructions and one or more processors that execute the instructions to: reduce turbulence in an image based on turbulence information; and correct, based on the turbulence information and a spatial change in luminance in the image, contrast of the image.

According to the second aspect of the present disclosure, there is provided an image processing apparatus comprising one or more memories storing instructions and one or more processors that execute the instructions to: reduce turbulence in an image based on turbulence information; and process, based on the turbulence information, a high-frequency component in a reduced image generated by the reduction, and generate an image obtained by adding the processed high-frequency component to the reduced image.

According to the third aspect of the present disclosure, there is provided an image processing apparatus comprising one or more memories storing instructions and one or more processors that execute the instructions to: reduce turbulence in an image based on turbulence information; and compress and encode the image at a compression ratio that accords with the turbulence information.

According to the fourth aspect of the present disclosure, there is provided an image processing method performed by an image processing apparatus, the method comprising: reducing turbulence in an image based on turbulence information; and correcting, based on the turbulence information and a spatial change in luminance in the image, contrast of the image.

According to the fifth aspect of the present disclosure, there is provided an image processing method performed by an image processing apparatus, the method comprising: reducing turbulence in an image based on turbulence information; and processing, based on the turbulence information, a high-frequency component in a reduced image generated by the reduction, and generating an image obtained by adding the processed high-frequency component to the reduced image.

According to the sixth aspect of the present disclosure, there is provided an image processing method performed by an image processing apparatus, the method comprising: reducing turbulence in an image based on turbulence information; and compressing and encoding the image at a compression ratio that accords with the turbulence information.

According to the seventh aspect of the present disclosure, there is provided a non-transitory computer-readable storage medium storing a computer program that causes a computer to function as: a reduction unit configured to reduce turbulence in an image based on turbulence information; and a correction unit configured to correct, based on the turbulence information and a spatial change in luminance in the image, contrast of the image.

According to the eighth aspect of the present disclosure, there is provided a non-transitory computer-readable storage medium storing a computer program that causes a computer to function as: a reduction unit configured to reduce turbulence in an image based on turbulence information; and a sharpening unit configured to process, based on the turbulence information, a high-frequency component in a reduced image generated by the reduction, and generate an image obtained by adding the processed high-frequency component to the reduced image.

According to the ninth aspect of the present disclosure, there is provided a non-transitory computer-readable storage medium storing a computer program that causes a computer to function as: a reduction unit configured to reduce turbulence in an image based on turbulence information; and a compression encoding unit configured to compress and encode the image at a compression ratio that accords with the turbulence information.

Further features of the present invention will become apparent from the following description of exemplary embodiments with reference to the attached drawings.

### BRIEF DESCRIPTION OF THE DRAWINGS

FIG. 1 is a block diagram illustrating an example of a functional configuration of an image processing apparatus.

FIG. 2 is a flowchart of operation of the image processing apparatus.

FIG. 3A is a diagram for explaining effects of turbulence on an input image.

FIG. 3B is a diagram for explaining effects of turbulence on an input image.

FIG. 3C is a diagram for explaining effects of turbulence on an input image.

FIG. 4A is a diagram for explaining a method of obtaining turbulence information in an input image.

FIG. 4B is a diagram for explaining a method of obtaining turbulence information in an input image.

FIG. 4C is a diagram for explaining a method of obtaining turbulence information in an input image.

FIG. 5A is a diagram for explaining an example of turbulence reduction processing by a reduction unit 102.

FIG. 5B is a diagram for explaining an example of turbulence reduction processing by the reduction unit 102.

FIG. 5C is a diagram for explaining an example of turbulence reduction processing by the reduction unit 102.

FIG. 6A is a diagram for explaining a problem with prior art.

FIG. 6B is a diagram for explaining a problem with prior art.

FIG. 7A is a diagram for explaining an effect of a first embodiment.

FIG. 7B is a diagram for explaining an effect of the first embodiment.

FIG. 7C is a diagram for explaining an effect of the first embodiment.

FIG. 8A is a diagram for explaining an effect of the first embodiment.

FIG. 8B is a diagram for explaining an effect of the first embodiment.

FIG. 9 is a block diagram illustrating an example of a functional configuration of the image processing apparatus.

FIG. 10 is a block diagram illustrating an example of a functional configuration of the image processing apparatus.

FIG. 11 is a diagram for explaining an effect of a third embodiment.

FIG. 12 is a block diagram illustrating an example of a functional configuration of the image processing apparatus.

FIG. 13 is a block diagram illustrating an example of a hardware configuration of a computer apparatus.

### DESCRIPTION OF THE EMBODIMENTS

Hereafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

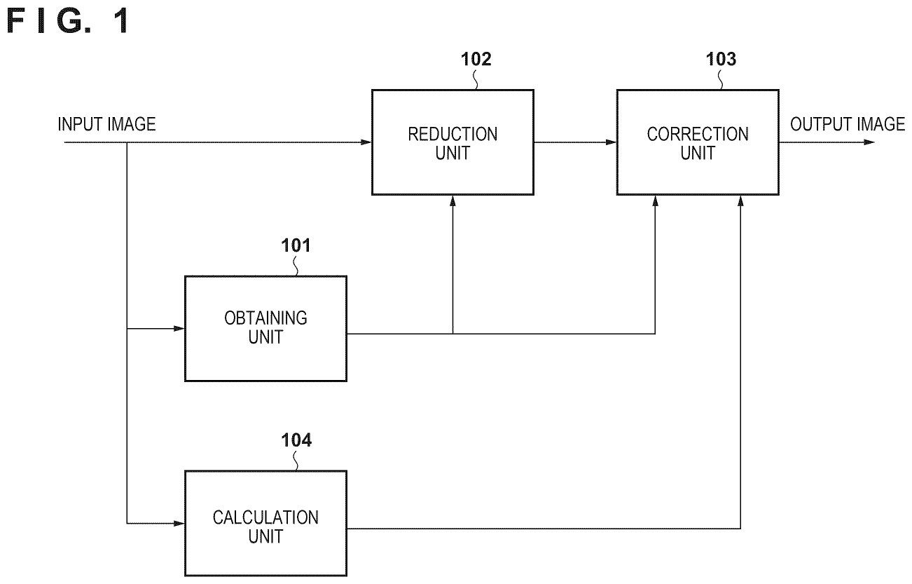

First, an example of a functional configuration of an image processing apparatus according to the present embodiment will be described with reference to a block diagram of FIG. 1. The image processing apparatus obtains an input image of a respective frame. The input image of a respective frame may be an image of a respective frame in a moving image, or may be a still image of a respective periodically or non-periodically captured frame.

An input image is a color image in which each pixel has pixel values of a plurality of color components. For example, the input image is an RGB color image in which each pixel has respective red (R), green (G), and blue (B) pixel values. Such an input image is, for example, an image generated in accordance with the amount of light transmitted through color filters corresponding to respective colors provided on an image sensor and converted into an electrical signal by the image sensor. However, the input image is not limited to a color image, and may be a monochrome image or the like. The input image is an image that may contain turbulence in a subject image caused by uneven changes in the refractive index of atmosphere (e.g., a heat haze).

A method for the image processing apparatus to obtain such an input image is not limited to a particular method. For example, when the image processing apparatus is an imaging apparatus, the image processing apparatus obtains, as an input image, a captured image of each frame captured by an imaging unit included in the apparatus itself. Further, the image processing apparatus may obtain, as an input image, an image captured by an external imaging apparatus or a captured image held in a computer apparatus such as an external server apparatus. A method and configuration for the image processing apparatus to obtain an input image are thus not limited to a particular method or configuration.

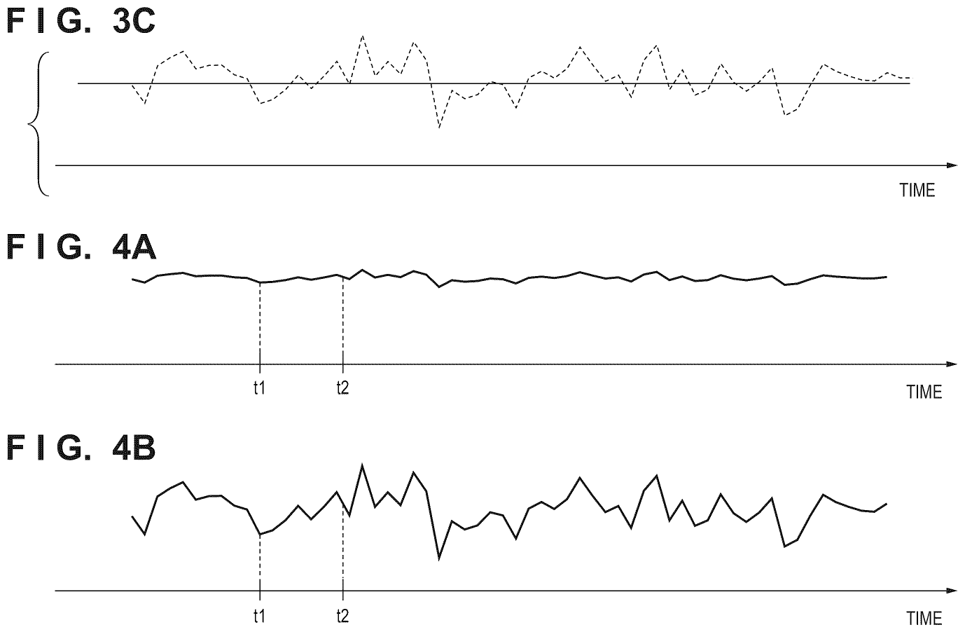

An obtaining unit 101 obtains, from an input image obtained by the image processing apparatus, turbulence information indicating an amount of turbulence (degree of turbulence) included in the input image. Here, effects of turbulence on an input image will be described with reference to FIGS. 3A to 3C. FIG. 3A illustrates an example of a captured image (non-turbulent captured image) obtained by imaging a still subject in a state in which there is no turbulence. FIG. 3B illustrates an example of a captured image (turbulent captured image) obtained by imaging a still subject in a state in which there is turbulence.

As illustrated in FIGS. 3A and 3B, a phenomenon such as that in which even when a still subject is imaged, when imaging is performed in a state where there is turbulence, an image is captured in a distorted manner occurs. FIG. 3C indicates a pixel value at a pixel position P in non-turbulent captured image of each frame (solid line) and a pixel value at a pixel position P in a turbulent captured image of each frame (dashed line). In FIG. 3C, the horizontal axis indicates time (frame) and the vertical axis indicates the pixel value.

As indicated in FIG. 3C, the pixel value at the pixel position P in the non-turbulent captured image of each frame is substantially constant, and the pixel value at the pixel position P in the turbulent captured image of each frame changes. Therefore, when there is turbulence, a phenomenon in which a subject that should be still is imaged as though it were moving occurs.

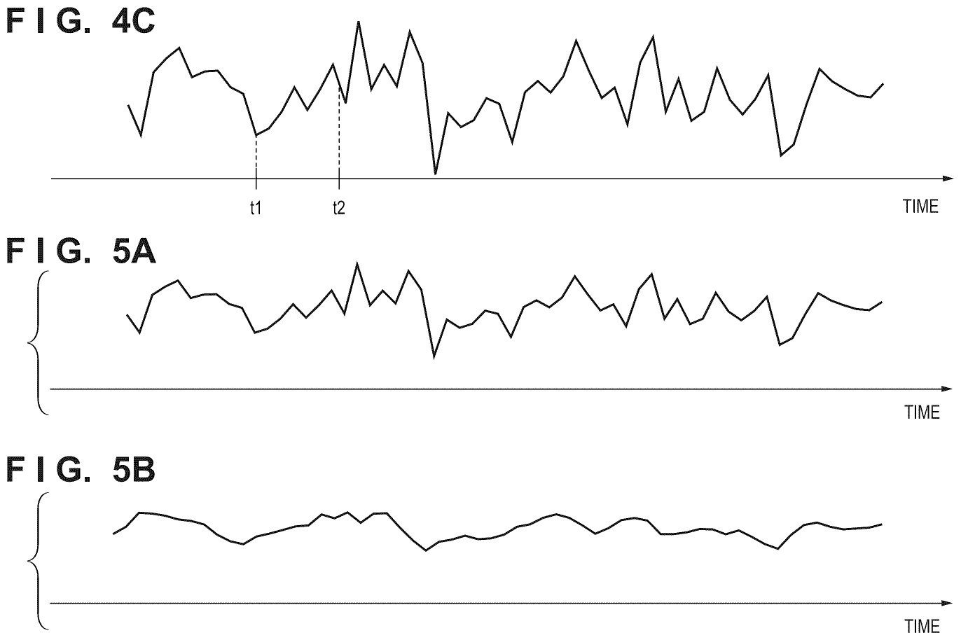

Next, a method for the obtaining unit 101 to obtain turbulence information in an input image will be described with reference to FIGS. 4A to 4C. FIGS. 4A to 4C indicate a pixel value of the same pixel position Q in an input image of each frame, and the horizontal axes indicate time (frame) and the vertical axes indicate pixel values. A change in pixel value illustrated in FIG. 4B is greater than a change in pixel value illustrated in FIG. 4A, and a change in pixel value illustrated in FIG. 4C is greater than a change in pixel value illustrated in FIG. 4B.

Here, it is assumed that a frame corresponding to time t2 is the current frame and a frame corresponding to time t1 is a past frame, which is one or more frames before the current frame. At this time, the obtaining unit 101 calculates a difference between a pixel value at the pixel position Q in an input image of the frame corresponding to time t2 and a pixel value at the pixel position Q in an input image of the frame corresponding to time t1. There are various methods of obtaining a difference between one pixel value and another pixel value (difference in pixel value between captured images), and the method is not limited to a particular method. For example, the obtaining unit 101 may calculate an absolute value of a difference between one pixel value and another pixel value as the difference between one pixel value and another pixel value. Further, the obtaining unit 101 may calculate a squared difference between one pixel value and another pixel value as the difference between one pixel value and another pixel value. The obtaining unit 101 thus calculates, for each pixel position in an input image of the current frame, a difference between a pixel value at that pixel position in that input image and a pixel value at that pixel position in a frame before the current frame (frame that is one or more frames before the current frame).

Then, the obtaining unit 101 calculates turbulence information of an input image of the current frame based on a difference calculated for each pixel position in the input image of the current frame. A method of calculating turbulence information of an input image of the current frame based on a difference calculated for each pixel position in the input image of the current frame is not limited to a particular method. For example, the obtaining unit 101 calculates, as turbulence information of an input image of the current frame, an average value, a total value, a value obtained by normalizing the total value, or the like of a difference calculated for each pixel position in the input image of the current frame.

A reduction unit 102 determines an intensity of turbulence reduction processing, which is processing for reducing turbulence in an input image, based on turbulence information obtained from an input image by the obtaining unit 101. Then, the reduction unit 102 executes turbulence reduction processing of the determined intensity on the input image. As turbulence reduction processing, smoothing processing (temporal (frame direction) smoothing (averaging) processing) for smoothing images of a plurality of frames and generating an image of the current frame, such as a simple moving average or weighted moving average between input images of a plurality of frames (an input image of the current frame and an input image of one or more frames before the current frame) is used.

The reduction unit 102 increases the intensity of turbulence reduction processing as the amount of turbulence (degree of turbulence) indicated by the turbulence information increases. For example, the reduction unit 102 increases the number of frames used for temporal (frame direction) smoothing processing as the amount of turbulence (degree of turbulence) indicated by the turbulence information increases (i.e., as the intensity of turbulence reduction processing increases). Further, for example, the reduction unit 102 increases the time in which frames to be smoothed have been captured as the amount of turbulence (degree of turbulence) indicated by the turbulence information increases (i.e., as the intensity of turbulence reduction processing increases).

Further, the reduction unit 102 decreases the intensity of turbulence reduction processing as the amount of turbulence (degree of turbulence) indicated by the turbulence information decreases. For example, the reduction unit 102 decreases the number of frames used for temporal (frame direction) smoothing processing as the amount of turbulence (degree of turbulence) indicated by the turbulence information decreases (i.e., as the intensity of turbulence reduction processing decreases). Further, for example, the reduction unit 102 decreases the time in which frames to be smoothed have been captured as the amount of turbulence (degree of turbulence) indicated by the turbulence information decreases (i.e., as the intensity of turbulence reduction processing decreases).

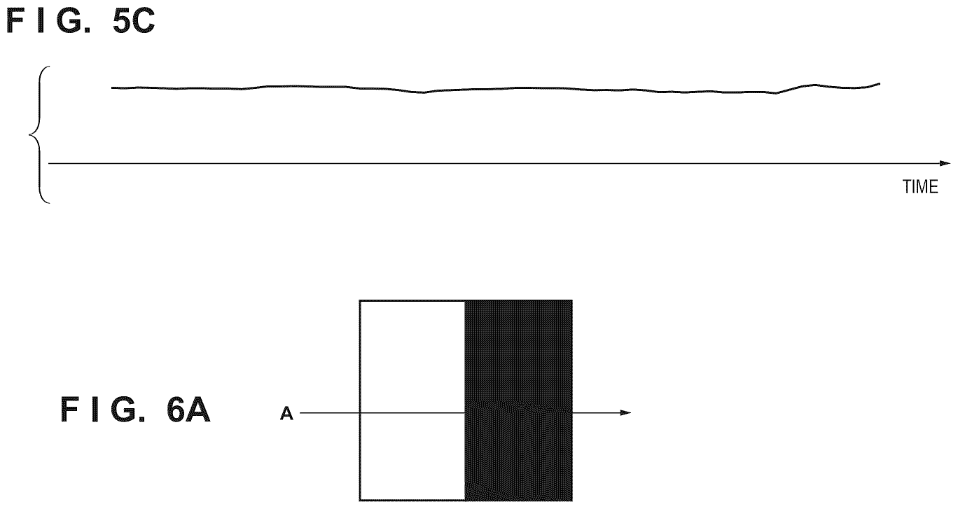

An example of turbulence reduction processing by the reduction unit 102 will be described with reference to FIGS. 5A to 5C. In FIGS. 5A to 5C, the horizontal axes indicate time (frames) and the vertical axes indicate pixel values. FIG. 5A indicates a pixel value at the same pixel position P in a turbulent captured image of each frame. FIG. 5B indicates a change in pixel value at the pixel position P of an image obtained by performing smoothing processing in which turbulence correction is at a first intensity on an input image (turbulent captured image) of FIG. 5A. Further, FIG. 5C indicates a change in pixel value at the pixel position P of an image obtained by performing smoothing processing in which turbulence correction is at a second intensity (>first intensity) on the input image (turbulent captured image) of FIG. 5A. A change in pixel value caused by turbulence is approximated to a normal distribution in which a predetermined position is a reference and can thus be reduced by frame direction smoothing processing.

The reduction unit 102 may change a weight used in the smoothing processing according to an intensity of turbulence reduction processing. For example, the reduction unit 102 may increase the value of the weight as the intensity of turbulence reduction processing increases, and decrease the value of the weight as the intensity of turbulence reduction processing decreases. Then, the reduction unit 102 generates an image of the current frame by performing smoothing processing using the value of the weight thus adjusted (changed). As such, which parameter in the smoothing processing to change according to the intensity of turbulence reduction processing is not limited a particular form.

A calculation unit 104 calculates a histogram (luminance histogram) of luminance values in an input image. A correction unit 103 corrects contrast of a reduced image, which has been generated by the reduction unit 102 performing turbulence reduction processing on the input image, based on the turbulence information obtained by the obtaining unit 101 and the luminance histogram calculated by the calculation unit 104.

The correction unit 103 increases emphasis of contrast of a reduced image as the amount of turbulence (degree of turbulence) indicated by the turbulence information increases. The correction unit 103 calculates a “spatial change in luminance of the input image” from the luminance histogram. For example, the correction unit 103 detects a plurality of peaks of luminance values from the luminance histogram and calculates a distance (luminance) between peaks as the “spatial change in luminance of the input image”. The “distance (luminance) between peaks” may be a maximum distance among distances between peaks, or may be an average value of distances between peaks. Further, the correction unit 103 increases emphasis of contrast of a reduced image as the distance (luminance) between peaks increases.

Then, the correction unit 103 outputs, as an output image, an image (input image in which contrast has been corrected) obtained by the correction. An output destination of the output image is not limited to a particular output destination. For example, the correction unit 103 may display the output image on a display unit (not illustrated) of the image processing apparatus, store the output image in a memory (not illustrated) of the image processing apparatus, or transmit the output image to an external apparatus via a network interface (not illustrated) of the image processing apparatus.

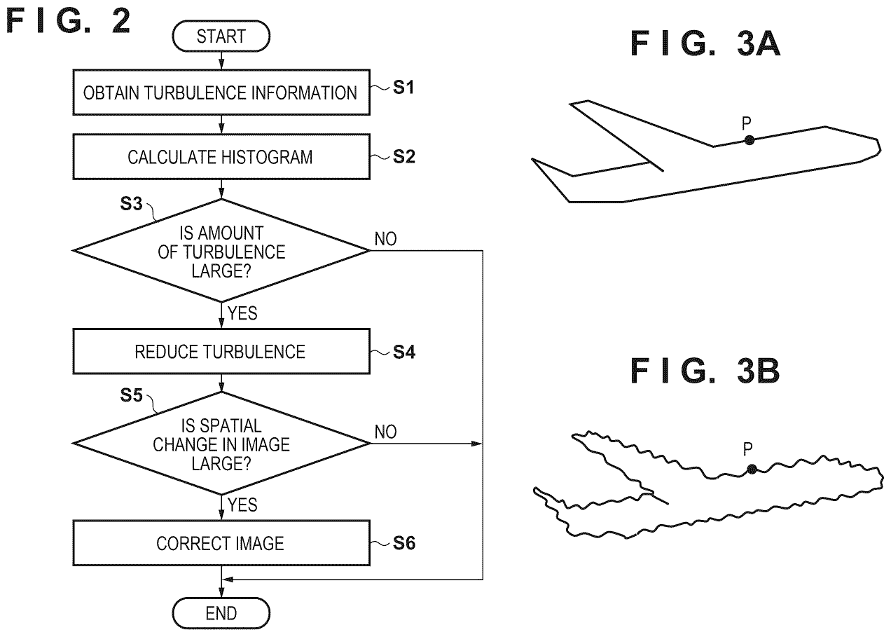

Next, operation of the image processing apparatus will be described according to a flowchart of FIG. 2. The processing according to the flowchart of FIG. 2 is performed for each input image inputted to the image processing apparatus.

In step S1, the obtaining unit 101 obtains turbulence information from an input image obtained by the image processing apparatus. In step S2, the calculation unit 104 calculates a histogram (luminance histogram) of luminance values in the input image.

In step S3, the reduction unit 102 determines whether an amount of turbulence indicated by the turbulence information (degree of turbulence) obtained in step S1 is large. For example, the reduction unit 102 determines that the amount of turbulence (degree of turbulence) indicated by the turbulence information obtained in step S1 is large if the amount of turbulence (degree of turbulence) indicated by that turbulence information is greater than or equal to a threshold. Meanwhile, the reduction unit 102 determines that the amount of turbulence (degree of turbulence) indicated by the turbulence information obtained in step S1 is small if the amount of turbulence (degree of turbulence) indicated by that turbulence information is less than the threshold.

As a result of such determination, if it is determined that the amount of turbulence (degree of turbulence) indicated by the turbulence information is large, the processing proceeds to step S4. Meanwhile, if it is determined that the amount of turbulence (degree of turbulence) indicated by the turbulence information small, the processing according to the flowchart of FIG. 2 ends.

In step S4, the reduction unit 102 determines an intensity of turbulence reduction processing according to the amount of turbulence indicated by the turbulence information (degree of turbulence) obtained in step S1. Then, the reduction unit 102 executes turbulence reduction processing of the determined intensity on the input image.

In step S5, the correction unit 103 calculates a “spatial change in luminance of the input image” from the luminance histogram and determines whether the “spatial change in luminance of the input image” is large. For example, the correction unit 103 detects a plurality of peaks of luminance values from the luminance histogram. The correction unit 103 determines that the “spatial change in luminance of the input image” is large if a distance (luminance) between peaks is greater than or equal to a threshold, and determines that “spatial change in luminance of the input image” is small if the distance (luminance) between peaks is less than the threshold. As described above, the “distance (luminance) between peaks” may be a maximum distance among distances between peaks, or may be an average value of distances between peaks.

As a result of such determination, if it is determined that the “spatial change in luminance of the input image” is large, the processing proceeds to step S6, and if it is determined that the “spatial change in luminance of the input image” is small, the processing according to the flowchart of FIG. 2 ends.

In step S6, the correction unit 103 corrects contrast of a reduced image, which has been generated by the reduction unit 102 performing turbulence reduction processing on the input image, based on the turbulence information obtained by the obtaining unit 101 and the luminance histogram calculated by the calculation unit 104. Then, the correction unit 103 outputs an image obtained by the correction as an output image.

The processing of determination in step S3 and the processing of determination in step S5 may be omitted as appropriate.

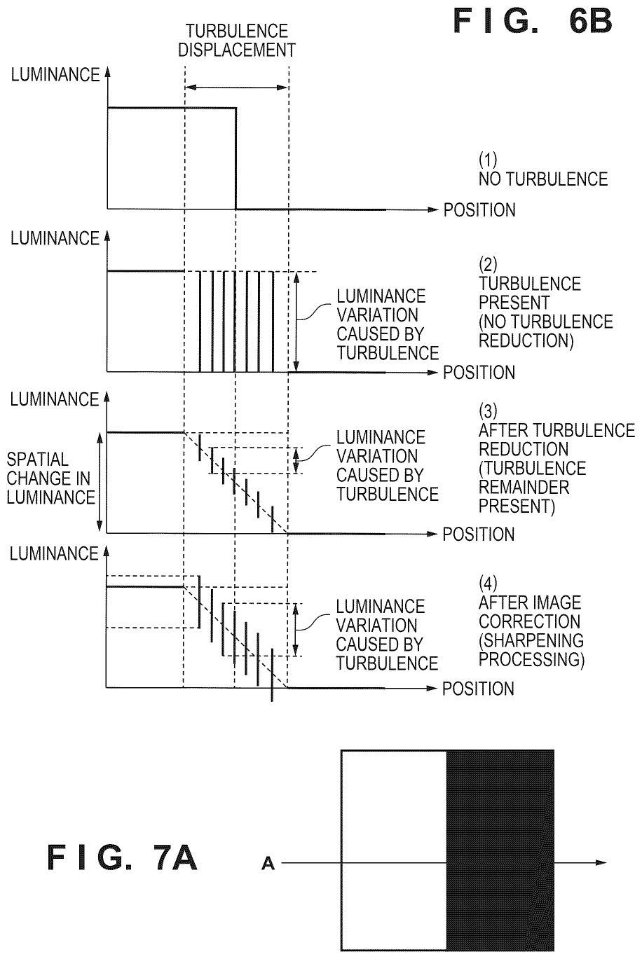

Here, a problem with prior art will be described with reference to FIGS. 6A and 6B. FIG. 6A illustrates an image having a high luminance region (region on the left side), which is a region of a pixel group having a high luminance value, and a low luminance region (region on the right side), which is a region of a pixel group having a low luminance value.

Graphs (1) to (4) illustrated in FIG. 6B indicate luminance values at respective pixel positions on horizontal line A of the image illustrated in FIG. 6A. The horizontal axes of these graphs indicate pixel positions on horizontal line A, and the vertical axes indicate luminance values.

Graph (1) indicates luminance values at respective pixel positions on horizontal line A of the image for when there is no turbulence, and graphs (2), (3), and (4) indicate luminance values at respective pixel positions on horizontal line A of the image for when there is turbulence.

More specifically, graph (2) indicates luminance values at respective pixel positions on horizontal line A of the image, which has not been subjected to turbulence reduction processing. When turbulence reduction processing is not performed, in a turbulence displacement range indicated in FIG. 6B, a luminance variation caused by turbulence occurs in a luminance range between a luminance of the high luminance region and a luminance of the low luminance region. This luminance variation caused by turbulence is illustrated using vertical solid lines in the turbulence displacement range in graph (2).

Graph (3) indicates luminance values at respective pixel positions on horizontal line A of the image, which has been subjected to turbulence reduction processing. Graph (3) indicates that due to an effect of turbulence reduction processing, a luminance variation caused by turbulence is smaller than that of graph (2). In addition, in the turbulence displacement range, the closer it is to the high luminance region, the more likely turbulence will occur on the high luminance side, and the closer it is to the low luminance region, the more likely turbulence will occur on the low luminance side. Therefore, regarding a central value (average value) of a luminance variation caused by turbulence after turbulence reduction processing, which is illustrated in graph (3), the closer it is to the high luminance region, the greater its luminance, and the closer it is to the low luminance region, the smaller its luminance. Due to this phenomenon, an image that has been subjected to turbulence reduction processing becomes more blurry than an image that has not been subjected to turbulence reduction processing.

Graph (4) includes illustration of turbulence for when image sharpening processing has been performed in order to correct the blurring of an image that has been subjected to turbulence reduction processing. When sharpening processing is performed, a local image change will be emphasized, and a luminance variation caused by turbulence will thus be emphasized. That is, a luminance variation caused by turbulence indicated in graph (4) ends up being greater than the luminance variation caused by turbulence indicated in graph (3). As a result, a turbulence remainder becomes emphasized, and the effect of turbulence reduction is thus weakened.

Further, since turbulence is caused by a disordered change in the refractive index of atmosphere, in an image in which there is turbulence, there will be random distortion and shaking of a subject image and artifacts, such as mosquito noise. Since these image changes due to turbulence appear as relatively high-frequency image changes, when a high-frequency component is emphasized by sharpening processing of an image, there is a possibility that turbulence may also end up being emphasized.

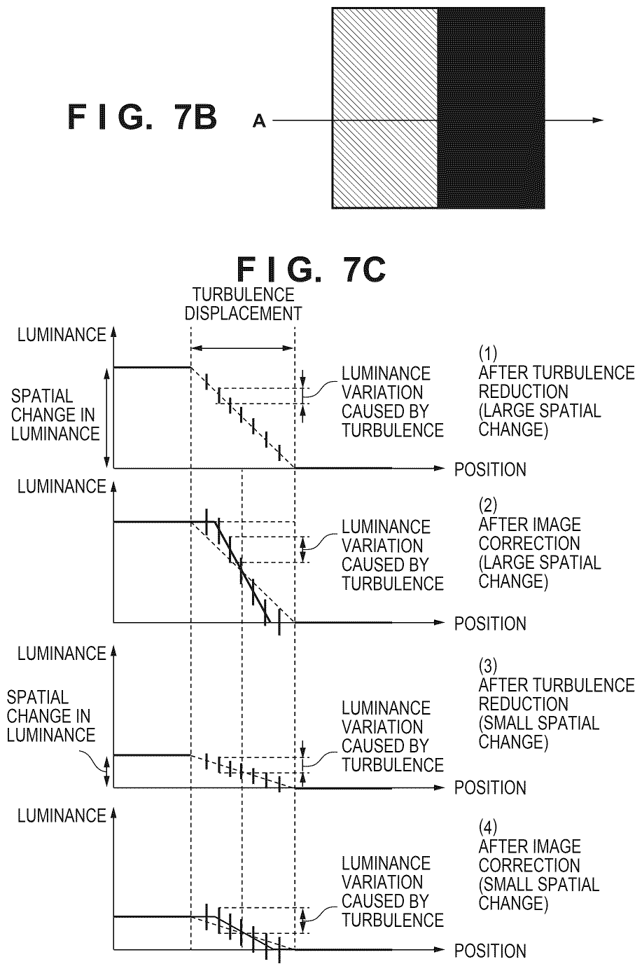

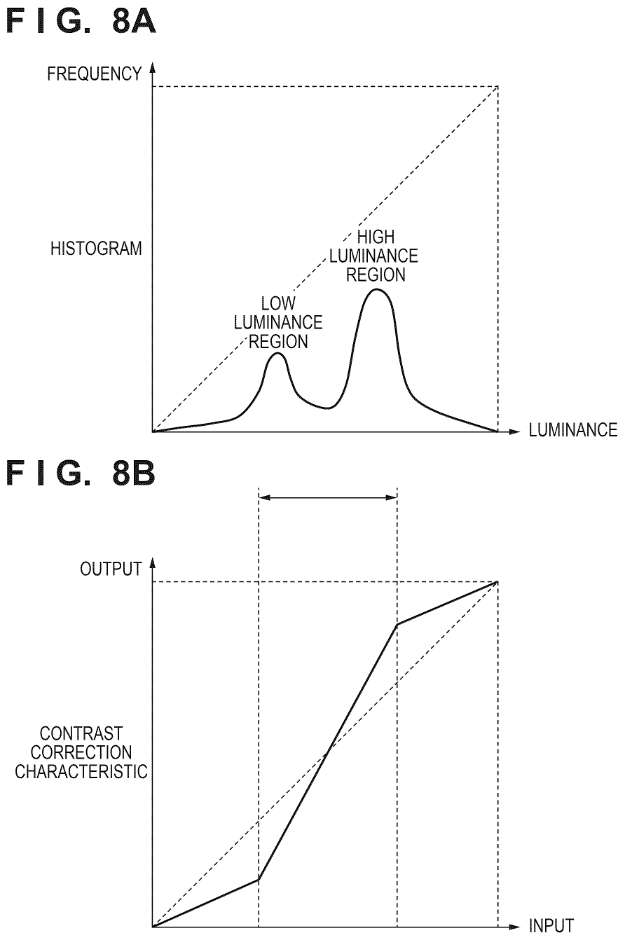

Next, an effect of the present embodiment will be described with reference to FIGS. 7A to 7C and FIGS. 8A and 8B. FIG. 7A illustrates an image P having a high luminance region (region on the left side) and a low luminance region (region on the right side). FIG. 7B illustrates an image Q having a high luminance region (region on the left side) and a low luminance region (region on the right side). A difference in luminance value between the high luminance region and the low luminance region in the image P is larger than a difference in luminance value between the high luminance region and the low luminance region in the image Q. That is, the image P is an image in which a spatial change in luminance is large, and the image Q is an image in which a spatial change in luminance is small.

Graphs (1) and (2) illustrated in FIG. 7C indicate luminance values at respective pixel positions on horizontal line A of the image P illustrated in FIG. 7A. Graphs (3) and (4) illustrated in FIG. 7C indicate luminance values at respective pixel positions on horizontal line A of the image Q illustrated in FIG. 7B. The horizontal axes of these graphs indicate pixel positions on horizontal line A, and the vertical axes indicate luminance values.

Graph (1) indicates luminance values at respective pixel positions on horizontal line A of an image obtained by subjecting the image P to turbulence reduction processing. Graph (2) indicates luminance values at respective pixel positions on horizontal line A of an image obtained by emphasizing contrast of the image obtained by subjecting the image P to turbulence reduction processing. Graph (3) indicates luminance values at respective pixel positions on horizontal line A of an image obtained by subjecting the image Q to turbulence reduction processing. Graph (4) indicates luminance values at respective pixel positions on horizontal line A of an image obtained by emphasizing contrast of the image obtained by subjecting the image Q to turbulence reduction processing.

As a method of emphasizing contrast, using, for example, a luminance histogram (the horizontal axis indicates luminance values and the vertical axis indicates frequency of luminance values) illustrated in FIG. 8A as an example, a peak of luminance values in a high luminance region and a peak of luminance values in a low luminance region are first detected. Then, as illustrated in FIG. 8B, tones in an input image are converted using a tone characteristic in which more output tone values are allocated to tones corresponding to what are between the peaks, and tones of an output image are thereby obtained. In FIG. 8B, the horizontal axis indicates tones in an input image, and the vertical axis indicates tones in an output image.

As illustrated in graph (2), when a spatial change in luminance of the image is sufficiently large with respect to a luminance variation caused by turbulence, even if the luminance variation caused by turbulence increases due to contrast emphasis, it is possible to emphasize contrast and achieve a blur reduction effect in the image as a whole. Meanwhile, as illustrated in graph (4), when a spatial change in luminance of the image is small with respect to a luminance variation caused by turbulence, even if contrast is emphasized, the spatial change in luminance of the image will be buried in the luminance variation caused by turbulence, and it is thus difficult to achieve a contrast enhancement effect. Furthermore, since turbulence becomes emphasized due to contrast emphasis and the luminance variation caused by turbulence increases, the effect of turbulence reduction processing is weakened. Therefore, in such a case, it is better not to perform contrast emphasis or reduce a degree of contrast emphasis.

That is, when a spatial change in luminance of the image is large, by performing contrast emphasis on an image that has been subjected to turbulence reduction, it is possible to reduce blurring caused by turbulence reduction processing. Meanwhile, when a spatial change in luminance of the image is small, by not performing contrast emphasis on an image that has been subjected to turbulence reduction, it is possible to prevent a turbulence correction remainder from being emphasized. That is, it is possible to reduce blurring caused by turbulence reduction processing while preventing a turbulence correction remainder from being emphasized.

### Variation

In the present embodiment, the correction unit 103 controls contrast emphasis of the image based on the degree of turbulence and the amount of turbulence included in the input image but may control contrast emphasis of the image based on the intensity of turbulence reduction processing, for example. The intensity of turbulence reduction processing may be, for example, the number of frames or smoothing period used for temporal (frame direction) smoothing processing performed by the reduction unit 102. The intensity of turbulence reduction processing, for example, may be the intensity of turbulence reduction processing set by a user via a setting unit (not illustrated) or may be a value (e.g., size of a region) designating a region in which turbulence reduction processing is to be applied in the input image. The correction unit 103 increases emphasis of contrast of a reduced image as the intensity of turbulence reduction processing increases.

The correction unit 103 determines a magnitude of the “spatial change in luminance of the input image” by using a luminance histogram, but a method of determining the magnitude of the “spatial change in luminance of the input image” is not limited to a particular method.

For example, the correction unit 103 detects an edge in the input image by using a typical edge detection technique. Then, the correction unit 103 counts, for each region such as a peripheral region constituted by pixels (edge pixels) detected as an edge or a defined image region (e.g., image regions having the same attribute), the number of edge pixels belonging to that region. Then, the correction unit 103 determines that the “spatial change in luminance of the input image” is large if there is a region in which the number of counted edge pixels is greater than or equal to a threshold, and determines that the “spatial change in luminance of the input image” is small if there is no such region.

The correction unit 103 may determine a magnitude of the “spatial change in luminance of the input image” based on an edge intensity in the input image. For example, the correction unit 103 may determine that the “spatial change in luminance of the input image” is large if an indicator such as a maximum edge intensity in the input image or an average value of edge intensities in the input image is greater than or equal to a threshold. Meanwhile, the correction unit 103 may determine that the “spatial change in luminance of the input image” is small if the indicator is less than the threshold.

Further, in the present embodiment, the correction unit 103 increases emphasis of contrast of a reduced image as the amount of turbulence (degree of turbulence) indicated by turbulence information increases; however, other conditions for controlling emphasis of contrast of a reduced image are conceivable. For example, the correction unit 103 may increase emphasis of contrast as the intensity of turbulence reduction processing increases.

The correction unit 103 may cause the degree of contrast emphasis for when a condition that “the amount of turbulence (degree of turbulence) indicated by turbulence information is greater than or equal to a threshold and the intensity of turbulence reduction processing is less than a threshold” is satisfied to be less than the degree of contrast emphasis for when the condition is not satisfied.

Normally, it is assumed that the amount of turbulence included in the image and the intensity of turbulence reduction processing are proportional to each other. However, when the turbulence reduction processing is performed, image blur (motion blur) of a moving subject occurs, and thus, it is conceivable that in a scene, for example, in which there are many moving subjects, even if the degree of turbulence included in the image is large, the intensity of turbulence reduction processing is decreased. When the degree of turbulence included in the image is large and the intensity of turbulence reduction processing is small, turbulence is not reduced and thus remains (turbulence remainder). Then, if contrast is emphasized in a state where there is a turbulence remainder, turbulence ends up becoming emphasized. Therefore, by decreasing the degree of contrast emphasis when the degree of turbulence included in the image is large and the intensity of turbulence reduction processing is small, it is possible to prevent turbulence from being emphasized.

Further, in the present embodiment, an example in which the obtaining unit 101 uses a difference between input image frames when obtaining the amount and degree of turbulence as the turbulence information has been described, but the present invention is not limited thereto. For example, the obtaining unit 101 may assume a magnitude of turbulence displacement illustrated in FIGS. 6A and 6B and FIGS. 7A to 7C as the degree (amount) of turbulence and obtain information indicating that degree (amount) as the turbulence information.

The greater the magnitude of turbulence displacement, the greater the degree of turbulence. A turbulence displacement is an amount indicating a maximum or average amount a captured image of a subject has moved (appears to have moved) in an image space due to turbulence. Alternatively, the number of frames (turbulence period) necessary for a cumulative value of differences between frames to become what is predetermined or more may be used as the degree of turbulence. The smaller the turbulence period (smaller the number of frames necessary for a cumulative value of differences between frames to be what is predetermined or more), the greater the degree of turbulence.

In the present embodiment, the calculation unit 104 calculates the luminance histogram from the input image, but the luminance histogram is only one kind of information for obtaining “information necessary for calculating the spatial change in luminance of the input image”. That is, so long as such information can be obtained, the calculation unit 104 may obtain information other than the luminance histogram. For example, the calculation unit 104 may calculate, as such information, a statistic related to color in the input image or a statistic of R, G, and B pixel values in the input image.

The image processing apparatus may divide the input image into a plurality of pixel blocks and perform processing according to the flowchart of FIG. 2 for each pixel block. In this case, the image processing apparatus will obtain a pixel block of an output image corresponding to a respective pixel block in the input image. In that case, since the turbulence information and the luminance histogram are calculated for each pixel block, the intensity of turbulence reduction processing and the degree of contrast emphasis/correction tone characteristic will be the intensity and the degree/correction tone characteristic corresponding to the turbulence information of that pixel block. This allows for finer control, and thus, it is possible to further optimize a blur reduction effect and a turbulence reduction effect.

### Second Embodiment

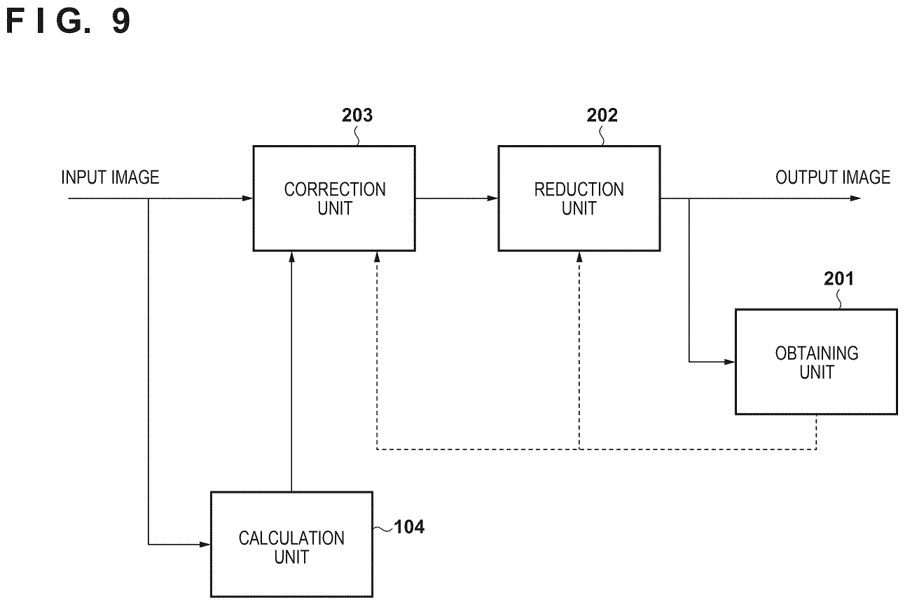

In each of the following embodiments including the present embodiment, differences from the first embodiment will be described, and unless otherwise mentioned below, it is assumed that the rest are similar to the first embodiment. First, an example of a functional configuration of an image processing apparatus according to the present embodiment will be described with reference to a block diagram of FIG. 9. In FIG. 9, functional units similar to the functional units illustrated in FIG. 1 are assigned the same reference numerals, and description pertaining to those functional units will be omitted.

An obtaining unit 201 operates similarly to the obtaining unit 101, and calculates, from an image obtained by a reduction unit 202 performing turbulence reduction processing on an n-th (n is an integer of 2 or more) frame (past frame), turbulence information indicating an amount of turbulence (degree of turbulence) included in the image.

The reduction unit 202 operates similarly to the reduction unit 102, and performs turbulence reduction processing on an (n+1)-th frame (current frame) image outputted from a correction unit 203 based on the turbulence information calculated by the obtaining unit 201 for the n-th frame and thereby generates an (n+1)-th frame output image. When the amount of turbulence (degree of turbulence) indicated by the turbulence information calculated by the obtaining unit 201 for the n-th frame is greater than or equal to a threshold, the reduction unit 202 performs, on the (n+1)-th frame image, turbulence reduction processing whose intensity is greater than the intensity of turbulence reduction processing performed for the n-th frame. When the amount of turbulence (degree of turbulence) indicated by the turbulence information calculated by the obtaining unit 201 for the n-th frame is less than the threshold, the reduction unit 202 performs, on the (n+1)-th frame image, turbulence reduction processing whose intensity is the same as the intensity of turbulence reduction processing performed for the n-th frame. With this, the intensity of turbulence reduction has converged. Alternatively, a configuration may be taken such that when it is detected that the amount (degree) of turbulence has converged to a predetermined value, the reduction unit 202 causes the intensity of turbulence reduction processing to converge. The reduction unit 202 outputs the generated output image. As in the first embodiment, the output destination of the output image is not limited to a particular output destination.

The correction unit 203 operates similarly to the correction unit 103, and corrects contrast of the (n+1)-th frame input image based on the turbulence information that the obtaining unit 201 calculated for the n-th frame and the luminance histogram that the calculation unit 104 calculated for the (n+1)-th frame. The correction unit 203 corrects contrast when the amount (degree) of turbulence indicated by the turbulence information that the obtaining unit 201 calculated for the n-th frame is less than the threshold or when it is determined that the amount (degree) of turbulence has converged.

As described above, according to the present embodiment, it is possible to determine the intensity of turbulence reduction processing and the degree of contrast emphasis of the next frame according to the amount (degree) of turbulence after the turbulence reduction processing. Therefore, it is possible to prevent excess or deficiency of the intensity of turbulence reduction processing and the degree of contrast emphasis, and it is possible to optimize effects of turbulence reduction and blur reduction.

### Third Embodiment

The present embodiment performs sharpening processing on an image that has been subjected to turbulence reduction processing and thereby improves blurring of the image caused by turbulence reduction processing, and performs sharpening processing according to the amount (degree) of turbulence and thereby prevents a turbulence correction remainder from becoming emphasized.

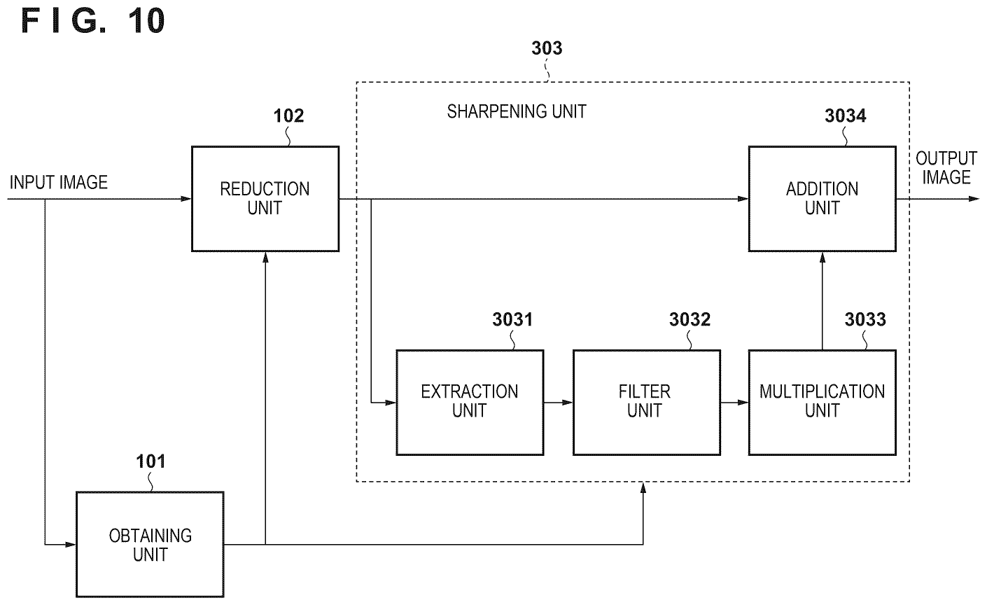

An example of a functional configuration of an image processing apparatus according to the present embodiment will be described with reference to a block diagram of FIG. 10. In FIG. 10, functional units similar to the functional units illustrated in FIG. 1 are assigned the same reference numerals, and description pertaining to those functional units will be omitted.

A sharpening unit 303 performs sharpening processing according to turbulence information calculated by the obtaining unit 101 on a reduced image obtained by the reduction unit 102 and thereby generates a “reduced image that has been subjected to sharpening processing”. The sharpening unit 303 outputs the generated “reduced image that has been subjected to sharpening processing” as an output image. As in the first embodiment, the output destination of the output image is not limited to a particular output destination. The sharpening unit 303 will be described in more detail below.

An extraction unit 3031 extracts a high-frequency component from a reduced image. For example, the extraction unit 3031 extracts a low-frequency component by applying a spatial low-pass filter (LPF) to the reduced image, and obtains a result of subtracting that low-frequency component from the reduced image as a high-frequency component.

A filter unit 3032 performs filter processing on the high-frequency component extracted by the extraction unit 3031 according to the turbulence information calculated by the obtaining unit 101. The filter processing is, for example, processing in which a typical Gaussian filter is used. The filter unit 3032 applies a Gaussian filter to a high-frequency component such that the greater the amount of turbulence (degree of turbulence) indicated by the turbulence information or the greater the intensity of turbulence reduction processing, the greater the blurring of the high-frequency component. The greater the amount (degree) of turbulence, the greater the possibility that the turbulence correction remainder may be emphasized, and thus, it is better that the greater the amount (degree) of turbulence, the greater the blurring of the high-frequency component. Furthermore, fluctuation (turbulence component) in an image caused by turbulence included in a high-frequency component is likely to appear particularly as a high-frequency signal among high-frequency components. In addition, the greater the amount (degree) of turbulence, the greater the fluctuation (turbulence component) in the image caused by turbulence included in the high-frequency component. Therefore, by increasing blurring of the high-frequency component as the amount (degree) of turbulence increases, it is possible to remove or reduce the turbulence component included in the high-frequency component. By the high-frequency component thus being processed based on the turbulence information, the turbulence correction remainder is prevented from becoming emphasized.

A multiplication unit 3033 multiplies the high-frequency component that has been subjected to the above filter processing by a gain that accords with the turbulence information calculated by the obtaining unit 101. The multiplication unit 3033 increases the gain as the amount of turbulence (degree of turbulence) indicated by the turbulence information increases or the intensity of turbulence reduction processing increases. The greater the amount (degree) of turbulence or the greater the intensity of turbulence reduction processing, the greater the blurring of the image that has been subjected to turbulence reduction processing, and thus, by the gain being increased to increase the intensity of the high-frequency component, the blur reduction effect can be more easily obtained. An addition unit 3034 generates, as an output image, a result of adding, to a reduced image, the high-frequency component that the multiplication unit 3033 multiplied by the gain, and outputs the generated output image.

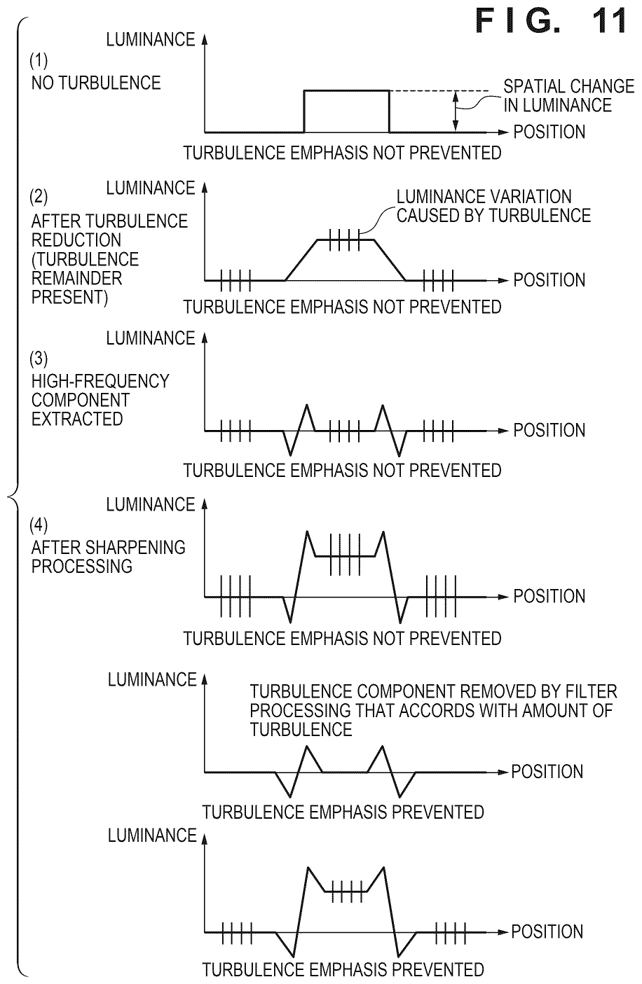

An effect of the present embodiment will be described below with reference to FIG. 11. Graphs (1) to (4) illustrated in FIG. 11 indicate luminance values at respective pixel positions in a portion (e.g., the above horizontal line A) of an image. The horizontal axes of these graphs indicate pixel positions in that portion, and the vertical axes indicate luminance values.

Graph (1) is a graph representing luminance values at respective pixel positions in a portion of an image for when there is no turbulence. Graph (2) is a graph including illustration of a luminance variation caused by turbulence. Compared with graph (1), edges are blurred due to turbulence reduction processing, and a luminance variation caused by turbulence has occurred.

The left graph of (3) is a graph indicating a high-frequency component extracted from the image of graph (2) in a conventional example in which a turbulence remainder is not prevented from being emphasized. Since turbulence appears in the image as spatially high-frequency fluctuation, the extracted high-frequency component contains a luminance variation caused by turbulence.

The left graph of (4) is a graph indicating a result of performing sharpening processing on the image of graph (2) in a conventional example in which a turbulence remainder is not prevented from being emphasized. That is, the left graph of (4) is a result of adding graph (2) and the left graph of (3). As illustrated in the left graph of (4), in conventional sharpening processing, since sharpening is performed without taking the degree of turbulence into consideration, turbulence is emphasized together with sharpening of the image, and as a result, the effect of turbulence reduction processing is weakened.

The right graph of (3) is a graph indicating a high-frequency component extracted from the image of graph (2) in the present embodiment in which a turbulence remainder is prevented from being emphasized. A Gaussian filter or the like is applied to the high-frequency component indicated in the left graph of (3), and thus, the high-frequency component indicated in the right graph of (3) does not include a luminance variation caused by turbulence.

The right graph of (4) is a graph indicating a result of performing sharpening processing on the image of graph (2) in the present embodiment in which a turbulence remainder is prevented from being emphasized. That is, the right graph of (4) is a result of adding graph (2) and the right graph of (3). As illustrated in the right graph of (4), in the sharpening processing of the present embodiment, the high-frequency component is added to the original signal after the turbulence component is removed or reduced. Therefore, it is possible to perform sharpening while preventing the turbulence remainder from being emphasized. That is, it is possible to reduce blurring caused by turbulence reduction processing (averaging of an image in a frame direction) while preventing a turbulence correction remainder from being emphasized.

### Variation

The filter unit 3032 may remove a low-amplitude signal of the high-frequency component. That is, the filter unit 2032 may replace a signal whose absolute value is less than a threshold with 0 in the high-frequency component. With this, it is possible to sharpen a portion in which a luminance variation is large, such as an edge of a subject, while preventing a turbulence component whose luminance variation is relatively small from being emphasized, and it is possible to improve blurring caused by turbulence reduction.

Further, the sharpening unit 303 may perform the above sharpening processing only when it is determined that the spatial change in luminance of the image is large, or may perform the sharpening processing only for an edge portion (strong edge portion) having an edge intensity greater than or equal to the threshold.

If the spatial change in luminance of an image is small, such as when a high-frequency component is extracted as in the left graph of (3), a difference between a high-frequency component originating from a spatial change in luminance, such as an edge, and a high-frequency component originating from a luminance variation caused by turbulence will end up small. Therefore, it becomes difficult to emphasize only the high-frequency component originating from the spatial change in luminance, and there is a possibility that the turbulence correction remainder may end up being emphasized or blurring caused by turbulence reduction processing may not be reduced. By performing sharpening processing only when the spatial change in luminance of the image is large, or performing sharpening processing only for a strong edge portion, it becomes easier to separate a high-frequency component originating from a spatial change in luminance such as an edge and a high-frequency component originating from a luminance variation caused by turbulence. As a result, it is possible to prevent a turbulence correction remainder from becoming emphasized for a portion where a luminance variation is small while reducing blurring caused by turbulence reduction processing for a portion where a luminance variation is large, such as an edge of a subject, and thereby prevent a turbulence reduction effect from being weakened.

### Fourth Embodiment

The present embodiment corrects a compression ratio of an input image according to an indicator, such as the amount of turbulence, the degree of turbulence, or the intensity of turbulence reduction processing, and leaves the high-frequency component of the input image by decreasing the compression ratio of the input image when the indicator is large, and thereby prevents blurring of the input image.

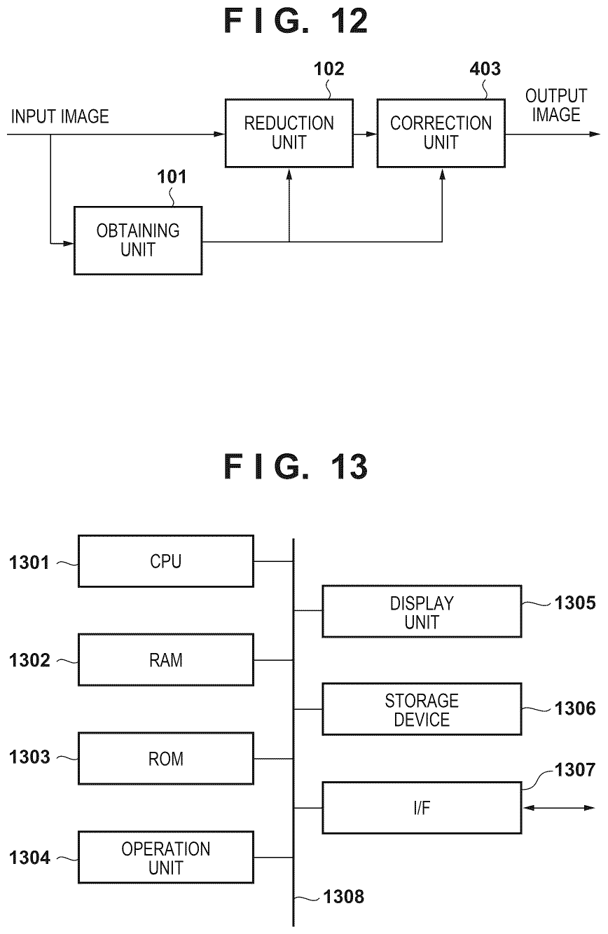

An example of a functional configuration of an image processing apparatus according to the present embodiment will be described with reference to a block diagram of FIG. 12. In FIG. 12, functional units similar to the functional units illustrated in FIG. 1 are assigned the same reference numerals, and description pertaining to those functional units will be omitted.

A correction unit 403 determines a compression ratio according to turbulence information calculated by the obtaining unit 101, performs compression encoding processing according to the compression ratio on a reduced image generated by the reduction unit 102, and outputs, as an output image, the reduced image that has been subjected to compression encoding. As in the first embodiment, the output destination of the output image is not limited to a particular output destination.

For example, the correction unit 403 decreases the compression ratio as the above indicator (amount of turbulence, degree of turbulence, or intensity of turbulence reduction processing) indicated by the turbulence information increases. Meanwhile, the correction unit 403 increases the compression ratio as the indicator (amount of turbulence, degree of turbulence, or intensity of turbulence reduction processing) decreases. For example, the correction unit 403 sets a quantization table used for compression encoding such that the greater the indicator, greater the amount of high-frequency component kept in the input image.

Since the high-frequency component of the image can be kept by decreasing the compression ratio when the intensity of turbulence reduction processing is high, blurring of the image caused by turbulence reduction processing can be reduced. Further, when the turbulence reduction processing is strongly applied, correlation between frames increases, and the efficiency of moving image encoding compression increases, and thus even if the compression ratio is decreased, it is possible to prevent an increase in the amount of data as the moving image.

Since turbulence is likely to appear as a high-frequency component in the image, when the high-frequency component is reduced by setting the compression ratio such that the compression ratio increases as the degree of turbulence increases, turbulence becomes less noticeable. Furthermore, in this case, there is no longer a need to strongly apply turbulence reduction processing, and thus, it is possible to prevent blurring caused by turbulence reduction processing.

### Fifth Embodiment

The respective functional units illustrated in FIGS. 1, 9, 10, and 12 may be implemented in software (computer program) or in hardware. In the former case, a computer apparatus capable of executing the software can be applied to the image processing apparatus of each of the above embodiments and variations. An example of a hardware configuration of such a computer apparatus will be described with reference to a block diagram of FIG. 13.

A CPU 1301 executes various processes using computer programs and data stored in a RAM 1302. The CPU 1301 thus performs control of operation of the entire computer apparatus and executes or controls various processes described as processes to be performed by the image processing apparatus of each of the above embodiments and variations.

The RAM 1302 includes an area for storing computer programs and data loaded from a ROM 1303 and a storage device 1306 and an area for storing computer programs and data received externally via an I/F 1307. In addition, the RAM 1302 includes a work area that the CPU 1301 uses when performing various processes. The RAM 1302 can thus provide various areas as appropriate.

The ROM 1303 stores setting data of the computer apparatus, computer programs and data related to startup of the computer apparatus, computer programs and data related to a basic operation of the computer apparatus, and the like.

An operation unit 1304 is a user interface such as a keyboard, a mouse, and a touch panel screen, and can input various kinds of instructions and information to the computer apparatus by being operated by the user.

A display unit 1305 includes a liquid crystal screen or a touch panel screen, and can display a result of processing by the CPU 1301 by using images, characters, and the like. The display unit 1305 may be a projection device such as a projector for projecting images and characters.

The storage device 1306 is a mass information storage device such as a hard disk drive device. The storage device 1306 stores an OS, computer programs and data for causing the CPU 1301 to execute or control various processes described as processes to be performed by the image processing apparatus of each of the above embodiments and variations, and the like.

The I/F 1307 is a communication interface for performing data communication with an external apparatus via a network such as a LAN or the Internet. For example, the computer apparatus can obtain an input image from an external imaging apparatus or server apparatus via the I/F 1307.

The CPU 1301, the RAM 1302, the ROM 1303, the operation unit 1304, the display unit 1305, the storage device 1306, and the I/F 1307 are all connected to a system bus 1308. The configuration illustrated in FIG. 13 is only one example of a hardware configuration of a computer apparatus capable of executing various processes described as processes to be performed by the image processing apparatus of each of the above embodiments and variations, and can be appropriately modified/changed.

The numerical values, processing timing, processing order, processing entity, data (information) obtainment method/transmission destination/transmission source/storage location, and the like used in each of the above embodiments and variations have been given as examples for the sake of providing a concrete explanation, and the present invention is not intended to be limited to such examples.

Further, some or all of the embodiments and variations described above may be appropriately combined and used. Further, some or all of the embodiments and variations described above may be selectively used.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image processing apparatus comprising one or more memories storing instructions and one or more processors that execute the instructions:
to reduce turbulence in an image based on turbulence information; and
to correct, based on the turbulence information and a spatial change in luminance in the image, contrast of the image.

2. The image processing apparatus according to claim 1, wherein a histogram of luminance values in the image is calculated, a peak of the luminance values in the histogram is detected, a distance between peaks is calculated as the change in luminance, and emphasis of the contrast of the image is increased as the distance increases.

3. The image processing apparatus according to claim 2, wherein, in a case when the distance is less than a threshold, the emphasis is not performed.

4. The image processing apparatus according to claim 1, wherein, whether the change in luminance is large based on the number of edge pixels in the image or an edge intensity in the image is determined, and in a case where it is determined that the change in luminance is large, the correction is performed, and in a case where it is determined that the change in luminance is small, the correction is not performed.

5. The image processing apparatus according to claim 1, wherein emphasis of the contrast of the image is increased as an amount of turbulence indicated by the turbulence information increases.

6. The image processing apparatus according to claim 5, wherein, in a case when the amount of turbulence indicated by the turbulence information is less than a threshold, the emphasis is not performed.

7. The image processing apparatus according to claim 1, wherein emphasis of the contrast of the image is increased as an intensity of the reduction increases.

8. The image processing apparatus according to claim 1, wherein a degree of contrast emphasis for when a condition that an amount of turbulence indicated by the turbulence information is greater than or equal to a threshold and an intensity of the reduction is less than a threshold is satisfied is caused to be smaller than a degree of contrast emphasis for when the condition is not satisfied.

9. The image processing apparatus according to claim 1, wherein turbulence in an image of a current frame is reduced based on turbulence information of a past frame, and
the image of the current frame is corrected based on the turbulence information of the past frame and a spatial change in luminance in the image of the current frame.

10. The image processing apparatus according to claim 9, wherein, if an amount of turbulence indicated by the turbulence information of the past frame is greater than or equal to a threshold, the turbulence in the image of the current frame is reduced at an intensity greater than an intensity at which turbulence in the image of the past frame is reduced.

11. The image processing apparatus according to claim 9, wherein, if an amount of turbulence indicated by the turbulence information of the past frame is less than a threshold, the turbulence in the image of the current frame is reduced at an intensity that is the same as an intensity at which turbulence in the image of the past frame is reduced.

12. An image processing apparatus comprising one or more memories storing instructions and one or more processors that execute the instructions:
to reduce turbulence in an image based on turbulence information; and
to process, based on the turbulence information, a high-frequency component in a reduced image generated by the reduction, and generate an image obtained by adding the processed high-frequency component to the reduced image.

13. The image processing apparatus according to claim 12, wherein filter processing in which blurring of a high-frequency component is increased is performed as an amount of turbulence indicated by the turbulence information increases, and the high-frequency component that has been subjected to the filter processing is multiplied by a gain that increases as the amount of turbulence indicated by the turbulence information increases.

14. The image processing apparatus according to claim 12, wherein a low-amplitude signal of the high-frequency component removed.

15. The image processing apparatus according to claim 12, wherein, in a case when it is determined that a spatial change in luminance in the image is large, the processing and the generation are performed.

16. The image processing apparatus according to claim 12, wherein the processing and the generation are performed on an edge portion having an edge intensity that is greater than or equal to a threshold.

17. An image processing apparatus comprising one or more memories storing instructions and one or more processors that execute the instructions:
to reduce turbulence in an image based on turbulence information; and
to compress and encode the image at a compression ratio that accords with the turbulence information.

18. The image processing apparatus according to claim 17, wherein the compression ratio is decreased as an amount of turbulence indicated by the turbulence information increases.

19. The image processing apparatus according to claim 17, wherein the compression ratio is decreased as a degree of turbulence indicated by the turbulence information increases.

20. The image processing apparatus according to claim 17, wherein the compression ratio is decreased as an intensity of the reduction increases.

21. The image processing apparatus according to claim 1, wherein the image is an input image or a respective one of pixel blocks obtained by dividing the input image.

22. The image processing apparatus according to claim 1, further comprising an imaging unit.

23. An image processing method performed by an image processing apparatus, the method comprising:
reducing turbulence in an image based on turbulence information; and
correcting, based on the turbulence information and a spatial change in luminance in the image, contrast of the image.

24. An image processing method performed by an image processing apparatus, the method comprising:
reducing turbulence in an image based on turbulence information; and
processing, based on the turbulence information, a high-frequency component in a reduced image generated by the reduction, and generating an image obtained by adding the processed high-frequency component to the reduced image.

25. An image processing method performed by an image processing apparatus, the method comprising:
reducing turbulence in an image based on turbulence information; and
compressing and encoding the image at a compression ratio that accords with the turbulence information.

26. A non-transitory computer-readable storage medium storing a computer program that causes a computer to function as:
a reduction unit configured to reduce turbulence in an image based on turbulence information; and
a correction unit configured to correct, based on the turbulence information and a spatial change in luminance in the image, contrast of the image.

27. A non-transitory computer-readable storage medium storing a computer program that causes a computer to function as:
a reduction unit configured to reduce turbulence in an image based on turbulence information; and
a sharpening unit configured to process, based on the turbulence information, a high-frequency component in a reduced image generated by the reduction, and generate an image obtained by adding the processed high-frequency component to the reduced image.

28. A non-transitory computer-readable storage medium storing a computer program that causes a computer to function as:
a reduction unit configured to reduce turbulence in an image based on turbulence information; and
a compression encoding unit configured to compress and encode the image at a compression ratio that accords with the turbulence information.
